(19) United States
(12) Patent Application Publication
(10) Pub. No.: US 2006/0132766 A1
(43) Pub. Date: Jun. 22, 2006

(54) Continuously tunable external cavity diode laser

(76) Inventors: Bruce Richman, Sunnyvale, CA (US); Giacomo Vacca, Santa Clara, CA (US); Guido Knippels, Sunnyvale, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/018,632

(22) Filed: Dec. 21, 2004

(51) Int. Cl. G01J 3/30

(52) U.S. Cl. 356/318; 356/331

(57) ABSTRACT

A cavity-enhanced spectrometer light source comprises: i) an electrically pumped SCDL having first and second facets at least said first facet being anti-reflection coated, ii) a diffraction grating facing said first facet, iii) a collimating lens interposed between said facet and said diffraction grating, iv) means for translating said lens substantially perpendicular to the path of the light beam transmitted from said SCDL to said diffraction grating to provide coarse tuning of the emission wavelength of said SCDL, and v) means for altering at least one of the temperature of and current to said SCDL to provide fine tuning of the emission wavelength of said SCDL.

### FIELD OF THE INVENTION

This invention relates generally to continuously tunable external cavity diode lasers for use in cavity-enhanced spectroscopy, and particularly to a compact, improved tuning system that avoids tuning discontinuities by maintaining a constant integral number of half wavelengths over at least a portion of the entire tuning range of the laser. The improved tuning system of the present invention suppresses mode hopping and reduces undesirable feedback.

### BACKGROUND OF THE INVENTION

Frequency-tunable semiconductor diode lasers are known as versatile optical tools for a variety of uses in telecommunications, metrology, spectroscopy and other applications. Many such tunable lasers use a diffraction grating with a movable reflector (mirror) to select a desired wavelength from the laser beam diffracted by the grating. Generally, a diode gain medium is employed that has an antireflection (AR) coating on one facet thereof. Light emitted from the AR coated facet is diffracted by a grating and directed to the mirror, which feeds light back to the grating and gain medium. Rotational movement of the reflector with respect to a pivot point selects the wavelength diffracted by the grating and allows the laser to be tuned to a desired output wavelength. Translational motion of the reflector is frequently employed in conjunction with the rotational motion to couple the cavity optical path length to the desired wavelength and provide mode-hop-free tuning.

Such semiconductor diode lasers are handicapped by the fact that the existing tuning mechanisms do not maintain a constant number of half wavelengths within the optical cavity. Variation in the angle of the mirror is used to select the desired wavelength, which is diffracted by the grating at the angle represented by the mirror position. While this approach provides a means for tuning the operating wavelength of the laser, it has been found that the mirror does not provide a smooth tuning action because rotation of the mirror about an arbitrary axis does not maintain the length of the tuning cavity at an integral number of half wavelengths. As the wavelength is varied and the number of waves in the cavity varies, the laser output exhibits discontinuities including large changes in output power and discontinuous changes in the emitted wavelength.

The basic principles of the operation of a tunable laser utilizing a variable-length external cavity in conjunction with a diffraction grating and a rotatable mirror are set forth in “Spectrally Narrow Pulse Dye Laser Without Beam Expander”, by M. G. Littman and H. J. Metcalf, Applied Optics, vol. 17, No. 14, pages 2224-2227, Jul. 15, 1978 and P. McNicholl and H. J. Metcalf, Applied Optics, vol. 24, no. 17, 2757-2761, Sep. 1, 1985. The Littman-Metcalf system utilizes a diffraction grating illuminated at a grazing angle with an incident collimated laser beam. The diffracted beam impinges at normal incidence onto a mirror, is reflected back onto the grating and, from there, diffracted back into the lasing medium, where it serves to determine the operating wavelength of the system. Rotation of the mirror to select the diffracted wave allows the system to be tuned to a desired output wavelength. Using this approach, a very high degree of precision in the rotation mechanism is required for mode-hop-free tuning, and additionally the tuning process is slow.

It was later recognized that simple rotation of the mirror did not provide a continuous single-mode scan over a range of wavelengths. The publication, “Novel Geometry for Single-Mode Scanning of Tunable Lasers” by Michael G. Littman and Karen Liu, (Optics Letters, Vol. 6, No. 3, pages 117, 118, March, 1981) describes a tunable laser cavity in which the mirror is rotated about a specified pivot point, to change the cavity length in correlation with the angle of the diffracted beam returned to the laser. Although the authors state that the pivot point selected by this method provides exact tracking for all accessible wavelengths, this is in fact true only for the case where there are no dispersive elements in the cavity, since the changes in optical length due to the effects of dispersion are not considered. Further information of a more general nature is available in “Introduction to Optical Electronics” by Amnon Yariv, 1976, published by Holt, Rinehart and Wilson; and “Optics” by Eugene Hecht, 1987, Addison-Wesley Publishing Co.

The shortcomings of tuning systems in which the mirror was only rotated was further discussed in “Synchronous Cavity Mode and Feedback Wavelength Scanning in Dye Laser Oscillators with Gratings” by Harold J. Metcalf and Patrick McNicholl, Applied Optics, Vol. 245, No. 17, pages 2757-2761, Sep. 1, 1985. The geometry described in this publication relates to positioning the point of rotation (pivot point) of the mirror at the intersection of the planes of the surface elements. The article suggests that for oscillators with mirrors as both end elements, a useful displaced configuration will also be synchronous. However, the displaced configurations will, again, be synchronous only in the absence of dispersive elements in the cavity.

A further development of the Littman-Metcalf configuration is set forth in “External-Cavity Diode Laser Using a Grazing-Incidence Diffraction Grating”, by K. C. Harvey and C. J. Myatt, Optics Letters, Vol. 16, No. 12, pages 910-912, Jun. 15, 1991, which describes a tunable cavity system utilizing a diode laser in which the diode laser has a highly reflective rear facet and an anti-reflection coated output facet with an output window. The output beam is collimated by a lens and illuminates a diffraction grating at a grazing angle. The first order of diffraction of the grating is incident on the mirror, which reflects it back onto the grating, where the first order of diffraction passes back into the diode laser. The output of the system is the zeroeth-order reflection from the grating. In this system, no mention is made of coordinated rotation and lineal translation of the mirror, or of a specific pivot point for rotation.

Another variable-wavelength design is described by J. B. D. Soule, et al., “Wavelength-Selectable Laser Emission From A Multistripe Array Grating Integrated Cavity Case,” Applied Physics letters, Vol. 61, No. 23, 7 Dec. 1992, pp. 2750-2752. In this device, single-output/selectable-wavelength operation was obtained by blazing a single “output” stripe on a grid and injection pumping different second stripes in order to obtain lasing at different wavelengths.

Numerous patents deal with wavelength tuning using moveable lenses and/or gratings, e.g., U.S. Pat. Nos. 5,524,012; 6,108,355; 6,252,897; 6,282,213; 6,301,274; 6,285,183 and 6,788,726. Recently, a variety of novel techniques have been applied to tuning diode lasers. For example, a variety of U.S. patents exist for laser tuning with alternative configurations of the mirrors at the cavity ends. U.S. Pat. No. 4,896,325 discloses an alternative cavity configuration in which a pair of mirrors, with narrow discontinuities that provide reflective maxima, bound the active cavity. These narrow bands of reflective maxima provide means for wavelength tuning which is actively controlled by a Vernier circuit. U.S. Pat. No. 4,920,541 discloses an external laser cavity configuration of multiple resonator mirrors used to produce multiple wavelength emission from a single laser cavity simultaneously or with a very fast switching time. Various mechanical arrangements for movement of the mirror have been devised to introduce simultaneous rotation and longitudinal translation in attempts to maintain the physical length of the laser cavity at a constant number of half wavelengths. One such a system is shown in U.S. Pat. No. 5,058,124. U.S. Pat. No. 5,319,668 discloses a tunable diode laser with a diffraction grating for wavelength separation and a movable mirror at the cavity end for wavelength selection. The pivot points are designed to provide a laser cavity length specific for the production of several wavelengths. U.S. Pat. No. 5,771,252 discloses an external-cavity, continuously tunable wavelength source utilizing a cavity end reflector movable about a pivot point for simultaneous rotation and translation for wavelength selection.

In addition, several U.S. patents disclose the use of alternative components in the laser cavity configuration in order to achieve wavelength tuning. U.S. Pat. No. 4,216,439 discloses a spectral line selection technique that utilizes a spectral line selection medium in the gain region of an unstable laser resonator cavity. U.S. Pat. No. 4,897,843 discloses a microprocessor-controlled laser system capable of broadband tuning by using multiple tuning elements, each with progressively finer linewidth control. U.S. Pat. No. 5,276,695 discloses a tunable laser capable of multiple wavelength emission simultaneously, or with a very fast switching time between wavelengths, by using a laser crystal in the cavity and fine rotation of the cavity end reflective element. U.S. Pat. No. 5,734,666 discloses a wavelength selection apparatus for a laser diode eliminating mechanical motion of a grating by utilizing a laser resonator for wavelength range selection and a piezoelectric-controlled crystal for specific wavelength selection.

Recent non-patent prior art also discloses relevant technology. In SPIE vol. 2482, pp. 269-274 by Zhang, et al., a microprocessor-controlled tunable diode laser that utilizes a stepper motor to rotate the grating for wavelength tuning is described. In addition, in SPIE vol. 3098, pp. 374-381 by Uenishi, Akimoto and Nagoka, a tunable laser diode with an external silicon mirror has been fabricated with MEMS technology and has wavelength tunability.

Wavelength-division multiplexed (WDM) optical communications systems require compact optical sources which can be tuned to specific channel wavelengths. The telecommunications prior art has frequently utilized a distributed feedback laser (DFB). Producing a DFB laser for a specific wavelength is a low-yield, statistical process, and a single DFB cannot be broadly tuned. Although external-cavity semiconductor lasers can be widely tuned to cover the entire band with a single unit, the existing grating-based designs are typically both large and delicate.

Versatility and low cost are especially desirable aspects of a tunable laser system to be used in spectroscopic applications. All of the previously described prior art designs are limited in their performance by one or more of the following: requiring complex mechanical motion, small wavelength range tunability, and/or specified or limited wavelength selection order. Especially for applications in spectroscopy, broadband, continuous wavelength tuning, arbitrary or simultaneous precise wavelength selection, and limited mechanical motion are highly desired characteristics. None of the known prior art designs provides a singular, compact, tunable light source that emits light with variable, but stable, wavelengths and stable light intensity that is thermally and mechanically insensitive and is especially suitable for cavity-enhanced spectroscopy applications.

Tables 1 and 2 show several theoretically possible alternatives for realizing a widely tunable laser in an external-cavity configuration. However, all these designs have major shortcomings with respect to linewidth/current noise and/or modulation. Moreover, all of the currently commercially available lasers cover only the telecommunications C-band, and although some might possibly be configured to cover the L-band, none covers the spectroscopically important ranges of 1380-1420 nm and 1660-1720 nm. These considerations suggest that development of a widely and continuously tunable laser, configurable for spectroscopic analysis and, in particular for use in cavity enhanced spectroscopy, would be highly desirable in the range around 1550 nm and would constitute a truly major advance if useable in the range of about 1300 nm to 1700 nm.

TABLE 1
Technologies potentially useful for realizing a widely tunable external-cavity laser

| | | | range | commercially | | |
|---|---|---|---|---|---|---|
| technology | vendor | speed [ms] | [nm] | available | plus | minus |
| galvo-driven grating | RGL | 10-100 | 150 | Y | workable, available | bulky, moving parts |
| grating + PZT-driven cavity lens | RGL | 1-10 | 40 | Y | workable, available | some tech. risk, medium |
| | | | | | | range |
| galvo-driven dielectric filter | Iridian | 1-10 | 30 | Y | known to work, | power drop-off in range, |
| | | | | | available | medium range, bulky, |
| | | | | | | moving parts |
| thermally tuned dielectric filter | Iridian | 100-1000 | <10 | N | no moving parts | tech. risk, small range |
| | | | | | | or large ΔT |
| thermally tuned dielectric filter | SLM | 100-1000 | 150 | N | no moving parts | tech. risk, small range |
| | | | | | | or large ΔT |
| voltage-tuned MEMS etalon | SLM | 1-10 | 150 | N | no ΔT | tech. risk, reliability, |
| | | | | | | high voltage |
| acousto-optic tunable filter | in house | <1 | 80 | Y | no moving parts | tech. risk, cost |
| PZT-driven Fresnel mirror | | 1-100 | 150 | N | ? | tech. risk |
| liquid-crystal tunable filter | | | | N | no moving parts | tech. risk |
| double electro-optic etalon | in house | <1 | | N | no moving parts | tech. risk, reliability, |
| | | | | | | high voltage |
| grating + thermal deflector | RGL + ? | 100-1000 | | ? | no moving parts | tech. risk |
| grating + MEMS mirror | RGL + ? | 1-10 | 150 | ? | compact | tech. risk |

TABLE 2
Possible solutions for realizing a widely tunable laser

| | | | speed | range | linewidth | power | cost | |
|---|---|---|---|---|---|---|---|---|
| technology | vendors | product | [ms] | [nm] | [MHz] | [mW] | [$] | available? |
| distributed feedback (DFB) array | Santur | TL2020-C | ? | 36 | 3 | 10/20 | 2.3k | yes |
| | Fujitsu | | ? | 12 | ? | 20 | | ? |
| external-cavity laser (ECL) | iolon | Apollo | 100 ? | 40 | 1 | 10/20 | 3k ? | yes |
| | Intel (New Focus) | Velocity | 20 nm/s | 50 | 0.3 | 20 | 25k | yes |
| sampled-grating distributed Bragg | Agility | 3105 | 10 | 40 | 5 | 10/20 | 3k ? | yes |
| reflector | | | | | | | | |
| (SGDBR) | Intune | AltoWave1300 | 10 | 80 | 15 | 8 | | yes |
| Vertical-cavity surface-emitting laser | Bandwidth9 | MetroFlex G2 | 1 | 20 | ? | 1 | | not yet |
| (VCSEL) | | | | | | | | |
| superstructure-grating DBR (SSGDBR) | NTT | | | | | | | ? |
| grating-coupled sampled reflector (GCSR) | none (formerly | | | | | | | no |
| | Altitun) | | | | | | | |

Cavity-enhanced spectroscopic methods resolve the sensitivity limitation inherent in conventional spectroscopy by increasing the effective path length of the light through the sample. Cavity-enhanced optical detection entails the use of a passive optical resonator (also referred to as a cavity). Integrated cavity output spectroscopy (ICOS) and cavity ring-down spectroscopy (CRDS) are two of the most widely used cavity-enhanced optical detection techniques. ICOS, as used herein, is intended to include a recent variant called off-axis ICOS where the light is injected into the resonator at an angle to the optical axis. The teaching of U.S. Pat. Nos. 5,528,040; 5,912,740; 6,795,190 and 6,466,322, which describe these techniques, are hereby incorporated herein by this reference. Although the present invention will be described primarily in the context of CRDS, it should be understood that it is also applicable to CEAS including ICOS and off-axis ICOS.

Cavity ring-down spectroscopy (CRDS) is based on the principle of measuring the rate of decay of light intensity inside a stable optical resonator, called the ring-down cavity (RDC). Once sufficient light is injected into the RDC from a laser source, the input light is interrupted, and the light transmitted by one of the RDC mirrors is monitored using a photodetector. The transmitted light, I(t,λ), from the RDC is given by the equation:

$$I ( t , λ ) = {I}_{0} {ⅇ}^{\frac{t}{τ ( λ )}} , \qquad Eq . 1$$

where I₀ is the transmitted light at the time the light source is shut off, τ(λ) is the ring-down time constant, and R(λ)=1/τ(λ) is the decay rate. The transmitted light intensity decays exponentially over time.

In CRDS, an optical source is usually coupled to the resonator in a mode-matched manner, so that the radiation trapped within the resonator is substantially in a single spatial mode. The coupling between the source and the resonator is then interrupted (e.g., by blocking the source radiation, or by altering the spectral overlap between the source radiation and the excited resonator mode). A detector typically is positioned to receive a portion of the radiation leaking from the resonator, which decays in time exponentially with a time constant τ. The time-dependent signal from this detector is processed to determine τ (e.g., by sampling the detector signal and applying a suitable curve-fitting method to a decaying portion of the sampled signal). Note that CRDS entails an absolute measurement of τ. Both pulsed and continuous-wave laser radiation can be used in CRDS with a variety of factors influencing the choice. The articles in the book “Cavity-Ringdown Spectroscopy” by K. W. Busch and M. A. Busch, ACS Symposium Series No. 720, 1999 ISBN 0-8412-3600-3, including the therein cited references, cover most currently reported aspects of CRDS technology.

Single-spatial-mode excitation of the resonator is also usually employed in ICOS (sometimes called CEAS)) although not in off-axis ICOS. ICOS/CEAS differs from CRDS in that the wavelength of the source is swept (i.e., varied over time), so that the source wavelength coincides briefly with the resonant wavelengths of a succession of resonator modes. A detector is positioned to receive radiation leaking from the resonator, and the signal from the detector is integrated for a time comparable to the time it takes the source wavelength to scan across a sample resonator mode of interest. The resulting detector signal is proportional to τ, so the variation of this signal with source wavelength provides spectral information on the sample. Therefore ICOS/CEAS entails a relative measurement of τ. The published Ph.D. dissertation “Cavity Enhanced Absorption Spectroscopy”, R. Peeters, Katholieke Universiteit Nijmegen, The Netherlands, 2001, ISBN 90-9014628-8, provides further information on both ICOS/CEAS and CRDS technology and applications. CEAS is also discussed in a recent article entitled “Incoherent Broad-band Cavity-enhanced Absorption Spectroscopy by S. Fiedler, A. Hese and A. Ruth, Chemical Physics Letters 371 (2003) 284-294. The teaching of U.S. Pat. No. 6,795,190 which describes ICOS and off-axis ICOS are also incorporated herein.

In cavity-enhanced optical detection, the measured ring-down time depends on the total round-trip loss within the optical resonator. Absorption and/or scattering by target species within the cavity normally account for the major portion of the total round-trip loss, while parasitic loss (e.g., mirror losses and reflections from intracavity interfaces) accounts for the remainder of the total round-trip loss. The sensitivity of cavity-enhanced optical detection improves as the parasitic loss is decreased, since the total round trip loss depends more sensitively on the target species concentration as the parasitic loss is decreased. Accordingly, both the use of mirrors with very low loss (i.e., a reflectivity greater than 99.99 percent), and the minimization of intracavity interface reflections are important for cavity-enhanced optical detection.

### OBJECTS OF THE INVENTION

It is an object of the present invention to provide a piecewise continuously tunable diode laser with broadband wavelength selection capability and a compact and robust form factor.

It is also an object of the present invention to provide a piece-wise continuously tunable diode laser with fast, broadband, wavelength selection capability in an arbitrary order.

It is another object of the invention to provide a laser whose wavelength can be scanned continuously with high spectral resolution and high precision over a narrow wavelength range for the purpose of spectroscopy.

It is also an object of the invention to provide a piece-wise continuously tunable diode laser with fast, broadband and precise wavelength selection capability in an arbitrary order that allows discrete switching between a predetermined series of wavelengths by mechanical translation of a lens.

It is also an object of the invention to provide a piece-wise continuously tunable diode laser which is resistant to mode hopping and which maintains an integral number of half wavelengths in the optical cavity over at least a portion of the entire tuning range of the laser.

It is also an object of the invention to provide a laser that emits light of a variable but stable wavelength and of stable intensity.

It is a further object of the present invention to provide a broadly tunable laser configurable for spectroscopic analysis in multiple wavelength regions, including, in particular, the regions around 1400 nm to 1700 nm.

### BRIEF DESCRIPTION OF THE DRAWINGS

FIG. 1 shows a Littrow configuration grating as used in the present invention having a grating angle γ and where the first-order beam is back aligned with the incident beam.

FIG. 2 shows a Littman-Metcalf configuration grating as used in the present invention wherein the first-order beam is directed to a mirror and then diffracted a second time on the grating.

FIG. 3 shows a graphic simulation plotting the relationship between incident angle on the grating and the intensity of the diffracted light in the retroreflected direction for selected wavelengths.

FIG. 4 shows results demonstrating the ability of the system of the present invention to lase on a single longitudinal mode across a broad spectral range.

FIG. 5 shows a prior-art external-cavity tunable laser configuration having a fixed lens and a pivoting grating.

FIG. 6 shows a tunable laser embodiment in accordance with the present invention having a fixed grating and a transversely movable lens.

FIG. 7 shows a prior-art tunable laser configuration with a fixed cavity lens and grating and a pivoting cavity mirror.

FIG. 8 shows a tunable laser embodiment in accordance with the present invention having a fixed grating and cavity mirror and a transversely movable cavity lens.

FIG. 9 shows a prior-art tunable laser configuration with a fixed cavity lens, fixed grating, fixed mirror lens, and translatable masked mirror.

FIG. 10 shows a tunable laser embodiment in accordance with the present invention having a fixed cavity lens, fixed grating blazed for zeroeth- and first-order diffraction, translatable mirror lens, and fixed masked mirror.

FIG. 11 shows a tunable laser embodiment in accordance with the present invention having a fixed cavity lens, fixed grating blazed for first-order diffraction, translatable mirror lens, fixed masked mirror, and a gain chip providing usable output from its front facet.

FIG. 12 shows additional components of a cavity ring-down spectrometer utilizing a tunable laser in accordance with the present invention.

FIG. 13 shows an embodiment of the present invention wherein a Littrow configuration grating is utilized in conjunction with a beam splitter and dipole detector to provide a feedback control loop.

FIG. 14 shows a configuration which utilizes the 1^{st}-order diffraction of a beam transmitted through the grating in conjunction with a dipole detector to provide a feedback control loop.

FIGS. 15 through 19 illustrate the use of a dipole detector in conjunction with a Littman-Metcalf grating configuration.

In FIG. 15 a beam splitter is positioned between the translatable lens and the grating.

In FIG. 16 the diffracted transmitted 2^{nd}-pass beam propagates as a mirror image.

In FIG. 17 the dipole detector is positioned behind a partially transmitting lens with a focusing lens positioned between the mirror and the dipole detector.

In FIG. 18 the dipole detector is positioned directly behind the mirror.

FIG. 19 shows an embodiment where a telescope re-images the location of the transmitted portion of the beam onto the front of the mirror.

### DESCRIPTION OF THE INVENTION

Our experiments indicate that our novel, diffraction-grating-based, external-cavity tunable laser architecture is capable of producing excellent performance in a cavity ring-down or other cavity-enhanced spectrometer. A wavelength-tunable laser according to the present invention comprises: i) a semiconductor diode laser mounted on a base element and having one facet (end plane) of a reduced reflection factor and positioned to illuminate; ii) a lens which faces the facet; iii) a grating-type reflector for reflecting light supplied from the facet via the lens in either a Littman-Metcalf or Littrow type configuration; and iv) means for precisely shifting the lens in a direction substantially perpendicular (orthogonal) to the axis of the lens to change an incident angle of the light to the grating. Furthermore, it is preferred that the focal point of the lens be substantially coincident with the above described end plane of the semiconductor laser. Moreover, it is preferred that the light emitted from the above described end plane be converted into parallel light. Also, it is preferred that the above described lens be an aspherical lens. The grating may be of either the holographic or blazed (ruled) type. In a particularly preferred embodiment of our invention, the cavity lens is linearly actuated by a piezoelectric element, resulting in angular sweeping of the beam emitted by the laser incident on the grating, thereby tuning it to the desired wavelength. This particular embodiment provides reduced size, higher speed, and enhanced wavelength stability. Other suitable means for translating the lens include, as an alternative to a PZT, an arcuate voice coil, a MEMS, thermal expansion and a manual or motorized micro-positioning screw. By piece-wise, mode hop free continuous tuning is meant that the cavity can access any wavelength within the tuning range of the laser but that the total tuning range must be considered as an overlapping series of segments and the laser is mode hop free, continuously tunable only within a given segment. To access another segment the laser must switch to another longitudinal mode corresponding to the longitudinal mode of the particular segment.

As above indicated, the external cavity laser suitable for the practice of the present invention can be in either the Littrow or Littman-Metcalf configuration. In the “Littrow” arrangement, the retroreflective dispersive element (grating) itself serves as a resonator end mirror, and in the “Littman-Metcalf” arrangement, the retroreflective dispersive element is positioned between the end mirrors of a folded resonator cavity. The end mirror and/or retroreflective dispersive element are varied in angle with respect to each other to control tuning or selection of desired laser output wavelengths.

It is desirable for spectroscopic applications that the system include additional means for finely adjusting the wavelength output of the laser. Suitable techniques include altering the temperature of the semiconductor chip by means such as thermoelectric (e.g., Peltier) units, resistive heaters and/or circulating air of variable temperature. Additional fine-tuning capability is normally achieved by providing a variable current source for altering the input current to the electrically pumped semiconductor diode laser chip.

The fundamental working principle of a diffraction grating is that interference between waves scattered from each illuminated groove of the grating will be constructive only when:
a(sin θₘ−sin θᵢ)=mλ, Eq. 2
wherein a is the groove spacing, θₘ the diffracted angle, θᵢ the incidence angle, m the diffraction order, and λ the wavelength of the incident light.

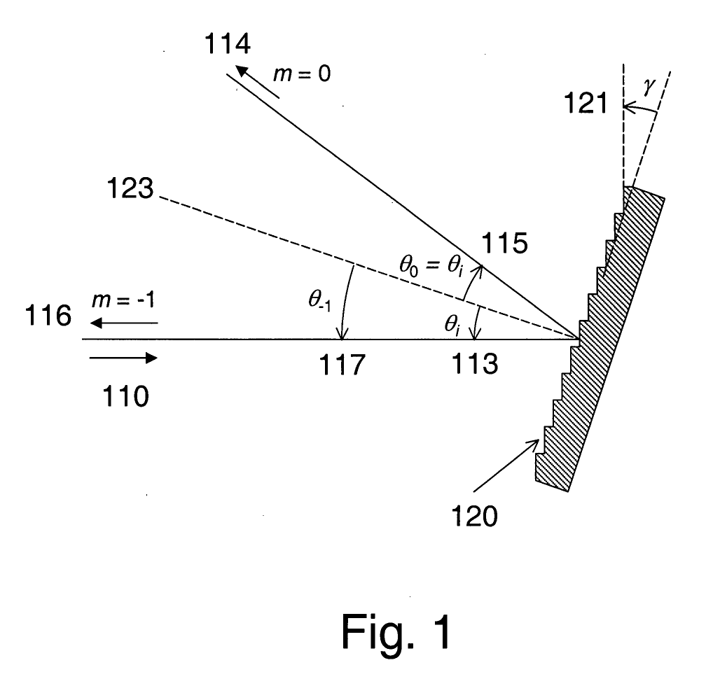

In the context of the present invention as shown in FIG. 1, we can use a grating (120) in the Littrow configuration (100), where the first-order diffracted beam (116) is backaligned with the incident beam (110) and thus m=−1 and θ₋₁=−θᵢ. No. (123) denotes a line normal to the grating plane, so that θᵢ (113) is the angle of incidence, which is equal in magnitude to θ₀ (115), the angle of the zeroeth-order diffracted beam (114), and to θ₋₁ (117), the angle of the first-order diffracted beam (116). This configuration, coupled with a suitable choice for the groove structure, allows for most of the laser power to be concentrated in the desired diffracted beam, yielding the highest possible efficiency. For the most advantageous choices of angles and groove densities for the desired wavelength, the first-order beam is generally preferred. To optimize diffraction into the first order where θ₋₁=−θᵢ, the blaze angle γ (121) of the grating should be substantially equal to θᵢ.

The diffraction formula for the Littrow configuration therefore becomes
2a sin θᵢ=λ. Eq. 3

For example, for a grating having a density of 1000 grooves/mm (a=1 μm) and an incident light wavelength of 1550 nm, θᵢ=50.8°.

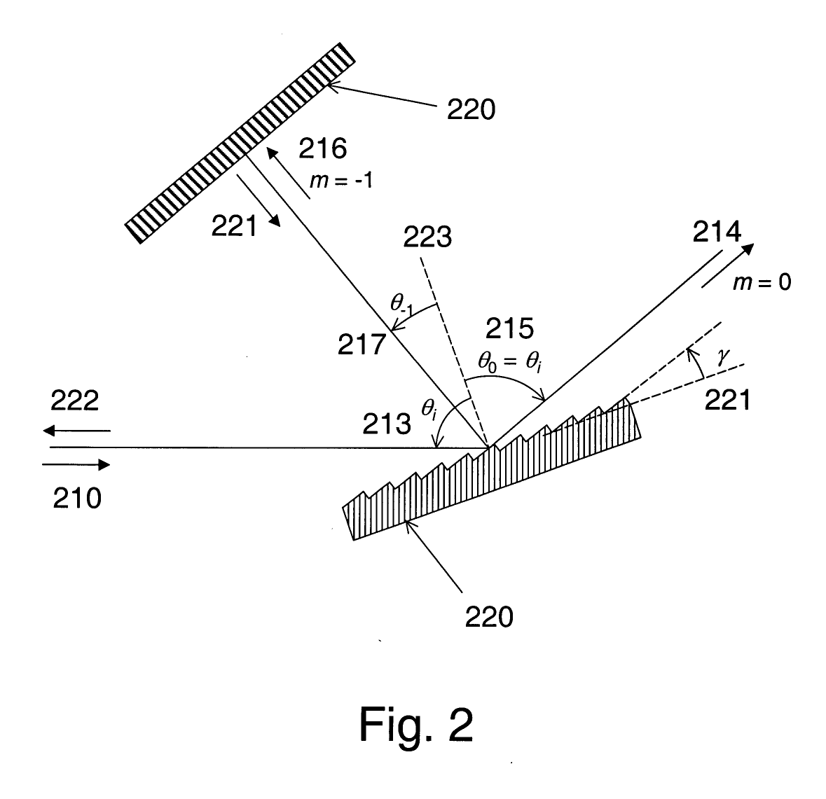

An alternative embodiment of the present invention (FIG. 2) makes use of a grating (220) in the Littman-Metcalf configuration (200), where the incident beam (210) is diffracted in the first order (216) towards a mirror (220) at normal incidence, backreflected (221) towards the grating and rediffracted back towards the source (222). In this geometry No. (223) denotes a line normal to the grating plane, so that θᵢ (213) is the angle of incidence, which is equal in magnitude to θ₀ (215), the angle of the zeroeth-order diffracted beam (214). The first-order diffracted beam (216) is at an angle θ₋₁ (217), which is given by Eq. (2) given the wavelength λ and suitable choices of groove spacing a and incident angle θₗ. The differences of this configuration with respect to the Littrow configuration are that the first-order diffracted beam (216) can be retroreflected towards the grating, where it undergoes one additional diffraction process, yielding superior spectral selection although with some loss in efficiency. In this second diffraction pass, No. (221) is now the incident beam, No. (222) is the first-order diffracted beam (which back-propagates along the original incident beam path (210)). The zeroeth-order diffracted beam is omitted for clarity. The blaze angle γ (221) of the grating can be varied to optimize different factors, depending on how this configuration is used. In one embodiment, the zeroeth-order diffracted beam from the first pass (214) is the useful output of this device, and the blaze angle can be chosen to maximize the intensity of this beam. In another embodiment, the second-pass first-order diffracted beam (222) is used to extract useful energy out of the device, with a corresponding different optimized value of the blaze angle γ.

There are three requirements for a grating to work effectively as a dispersive element in an external cavity laser:

(1) the diffracted beam must be of sufficient power;

(2) the angular dispersion needs to be sufficiently high, and

(3) the transfer function needs to be sufficiently narrow.

The first requirement is to ensure that there will be enough feedback to cause lasing; the second and third conditions ensure that lasing will occur in a single longitudinal mode. To satisfy the first condition, the grating must be biased to diffract most of the incoming light into the desired order, since all other orders are unused. This can be achieved by using either a blazed or a holographic grating. In either case the diffraction efficiency can be very high (˜90% diffraction into first order).

In order to satisfy the second and third requirements, it is useful to consider a practical reference point to derive a performance benchmark. Such guidance can be obtained from external-cavity lasers, and particularly those constructed having a semiconductor optical amplifier (SOA) as the gain medium and an etalon-based wavelength-selective cavity element. The figure of merit to consider is the subthreshold side-mode suppression ratio (SMSR), which represents the relative loss experienced in the subthreshold state by the nearest-neighbour longitudinal modes compared to the dominant mode. For a laser to operate stably in the single-mode regime, the SMSR will preferably be greater than about 0.3 dB.

One can translate the SMSR requirement to the case of a grating. In order to do so, two quantities need to be defined. For a grating in the Littrow configuration and such that the optical beam waist is coincident with the grating, the full-width half-maximum (FWHM) instrumental broadening Δθ₋₁, where a is the groove spacing and N is the number of grooves illuminated, is:

$$Δ {θ}_{- 1} = \frac{2 λ}{Na cos {θ}_{i}} , \qquad Eq . 4$$

and the angular dispersion is

$$\frac{ⅆ {θ}_{- 1}}{ⅆ λ} = \frac{2 tan {θ}_{i}}{λ} . \qquad Eq . 5$$

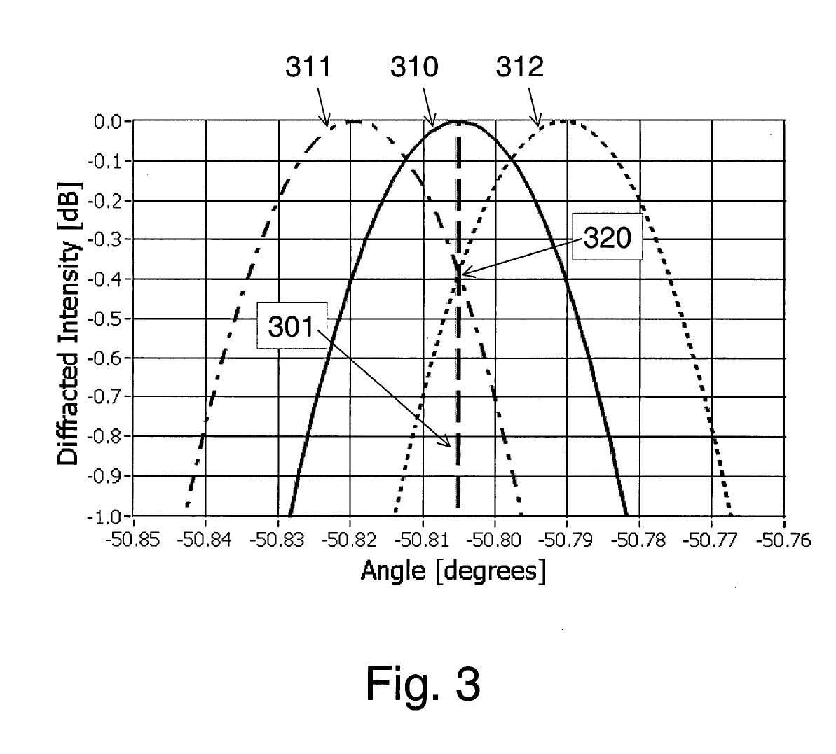

An analytical model, designed to explore the relationships between component specifications and performance parameters and informed with empirical data points, provides insight. FIG. 3 shows the results of a simulation plotting the relationship between incident angle on the grating and the intensity of the diffracted light in the retroreflected direction for three closely spaced wavelengths, with the incident direction shown as vertical line 301. Line 310 is the diffraction efficiency of the desired mode. Lines 311 and 312 are the adjoining cavity modes. What determines whether the laser will operate on a single longitudinal mode is the subthreshold strength of neighboring modes relative to the desired mode (intersection 320 of curves 311 and 312 with line 301). As can be seen, this will depend on both the instrumental broadening (how narrow the response function is—e.g., the width of curves 310, 311, and 312) and the angular dispersion (how well separated neighboring modes are—e.g., the separation between curves 310 and 311 and between curves 310 and 312).

In Eq. 4, the denominator Na cos θᵢ is the beam diameter, assuming that the entire beam diameter fits on the grating at angle θᵢ. For a fixed wavelength, the instrumental broadening will be a function only of how wide the beam can be made. On the other hand, if other constraints fix the beam diameter, one can affect side-mode rejection by increasing the groove density a and simultaneously increasing the grating angle θᵢ (Eq. 3) to keep the system in Littrow retroreflection. Then, as seen from Eq. 5, the separation of neighboring modes will increase, due to the increased angular dispersion.

Table 3 shows the result of simulations for a variety of cavity configurations. As indicated, the figure of merit is the side mode suppression ratio expressed in dB. For example, consider three cavity lenses that span two octaves in 1/e² beam diameters; and also consider two cavity lengths: 20 mm, for a mode spacing of 0.05 nm, and 2 mm, yielding a mode spacing of 0.16 nm. A groove density of 750 mm⁻¹ was chosen. Tests were performed using this grating in conjunction with a C-band laser. The laser was configured to leave the cavity lens intact (a Geltech 350140), but a Littrow grating was inserted at two different grating-to-lens distances (20 mm and 2 mm). The resulting spectral purity was observed.

TABLE 3
Calculated laser spectral purity (SMSR, in dB)
for several representative Littrow cavity configurations

| | | | SMSR [dB] fpr 750 grooves/mm | |
|---|---|---|---|---|
| | Focal | Beam | 20-mm cavity | 2-mm cavity |
| | length | diameter | FSR = 5.6 | FSR = 20 |
| Cavity lens | [mm] | [mm] | GHz = 0.05 nm | GHz = 0.16 nm |
| Alps | 0.75 | 528.6 | 0.004 | 0.04 |
| FLBF1Z101A | | | | |
| Geltech 350140 | 1.45 | 1022.0 | 0.01 | 0.14 |
| Geltech 350390 | 2.75 | 1938.2 | 0.05 | 0.49 |

The results conform to the expectations drawn from an etalon-based external-cavity laser benchmark and from the analytical investigation of a grating-based external-cavity laser. For the beam diameter given by the existing cavity lens, the 20-mm cavity did not go single-mode (second row in Table 3: SMSR=0.01 dB which is rather low), but the 2-mm cavity did support single-mode operation (also second row: SMSR=0.14 dB approximates the benchmark of 0.3 dB). Additional tests with angle tuning of the grating showed that the C-band laser was capable of supporting lasing across a ˜150-nm band, from 1425 to 1575 nm.

The tuning mechanism introduced in this invention involves linear translation of the cavity lens in the X direction (the direction perpendicular to the direction of the beam and in the plane of diffraction) to bring about angular displacement of the cavity beam, and therefore wavelength tuning in a Littrow cavity. There are practical advantages to such an arrangement, e.g., the feasibility of using a piezoelectric driver to translate the lens (since lens motion is linear) instead of the prior art approach of a galvo driver to pivot the grating (where motion must be angular). It also proved possible to arrange the cavity parameters so that translation of the lens automatically results in mode-hop-free tuning across the operating range.

The results of the analysis are shown in Table 4. The approach followed was to calculate the minimum groove density necessary to yield a sufficiently high SMSR (i.e., SMSR>0.3 dB) for use with each of the three cavity lenses under consideration, and in each case to calculate the associated tuning parameters (total angular displacement, linear-to-angular conversion for each lens, and resulting linear displacements) necessary to yield a 40-nm tuning range. The three configurations show the results of optimization for each of the three listed cavity lenses.

TABLE 4
Calculated tuning parameters for three choices of
lens-grating Littrow cavity configurations

| | | | | grooves/ | SMSR | Δθ for 40 nm | conversion | total travel |
|---|---|---|---|---|---|---|---|---|
| configuration | cavity lens | FL [mm] | 2 w₀ [μm] | mm | [dB] | tuning [°] | [μm/°] | [μm] |
| 1 | Alps FLBF1Z101A | 0.75 | 528.6 | 1200 | 0.46 | 3.75 | 15 | 56.3 |
| 2 | Geltech 350140 | 1.45 | 1022.0 | 1000 | 0.40 | 1.81 | 29 | 52.5 |
| 3 | Geltech 350390 | 2.75 | 1938.2 | 750 | 0.49 | 1.06 | 55 | 58.3 |

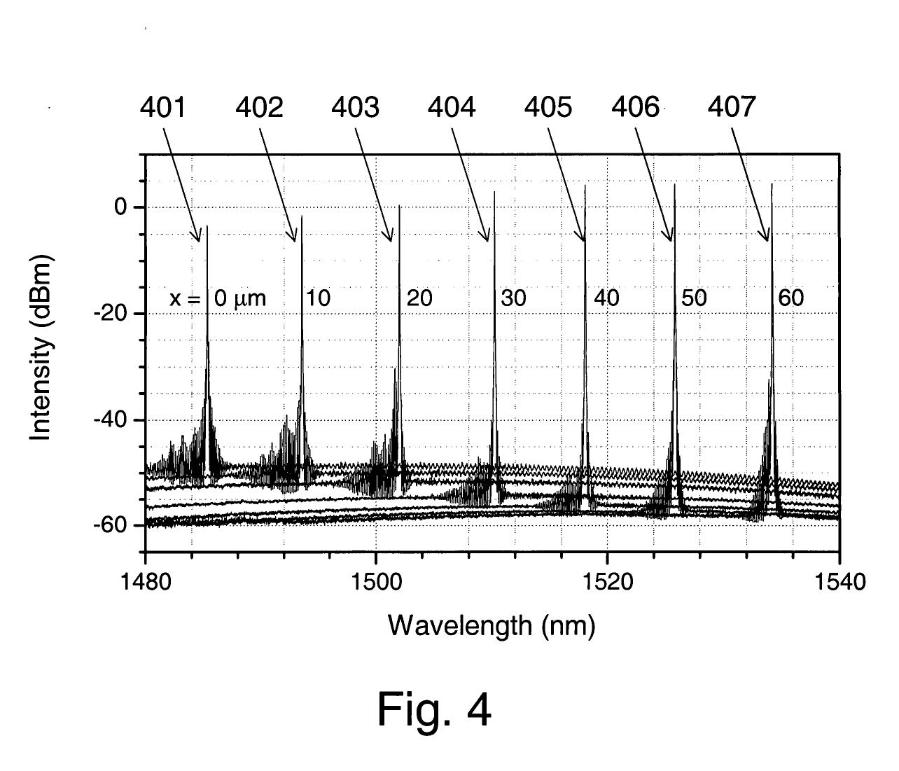

What should be noted is that the total linear travel necessary to cover 40 nm is substantially invariant (approximately 55 μm): a shorter-focal-length (FL) lens has a higher efficiency in converting linear translation into angular displacements, but the associated smaller cavity beam requires a higher groove density and larger grating angle to achieve a similar SMSR, which in turn increases the necessary angular displacement requirement. This extent of linear translation is achievable with commercially available piezoelectric units. The third row in Table 4 shows calculations for a configuration that was found to be particularly advantageous in practice. Here the cavity lens (Geltech 350390) was translated, while the grating was kept fixed. The SMSR for such a configuration (0.49 dB) is well above that needed for robust single-mode operation (0.3 dB). The results of a practical embodiment of such a configuration are shown in FIG. 4. With the diode current just above threshold (120 mA), such a system lased in single mode across a wide spectral region extending well beyond the gain peak (peak 406 at 1525 nm). The side modes were 45 dB below the lasing mode when the lasing mode was near the gain peak and about 20 dB below the lasing mode near the edge of the accessible lasing band (peak 401 at 1485 nm). By translating the lens transversely as indicated by the different values of X, we were able to tune 55 nm at a wavelength λ˜1500 nm with 60 μm of motion, in substantial agreement with the calculations.

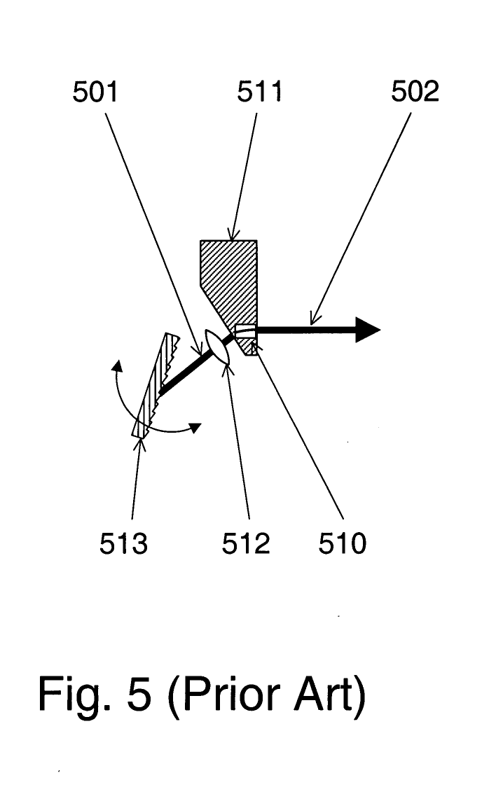

The prior art describes an external-cavity Littrow configuration (FIG. 5) where a relatively long-focal-length cavity lens (512) is fixed in place to collimate emission from gain chip (510) on mount (511), and the grating (513) is actuated (e.g., by a galvo motor, not shown) to provide angular displacement, yielding wavelength tuning in the cavity beam (501) and therefore in the laser output (502).

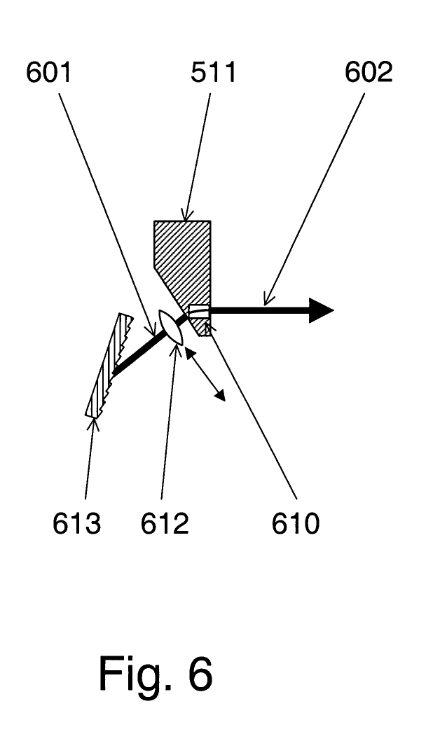

In one preferred Littrow-configuration embodiment of the present invention (FIG. 6), a shorter-focal-length cavity lens (612) is actuated, e.g., by a PZT element (not shown) to obtain transverse translation, resulting in angular displacement of cavity beam (601) at the fixed grating (613) and therefore wavelength tuning. The gain chip (610) is fabricated in structure and in the nature and quality of its optical coatings to provide for substantial emission of optical energy (601, 602) from both of its facets in desired ratios.

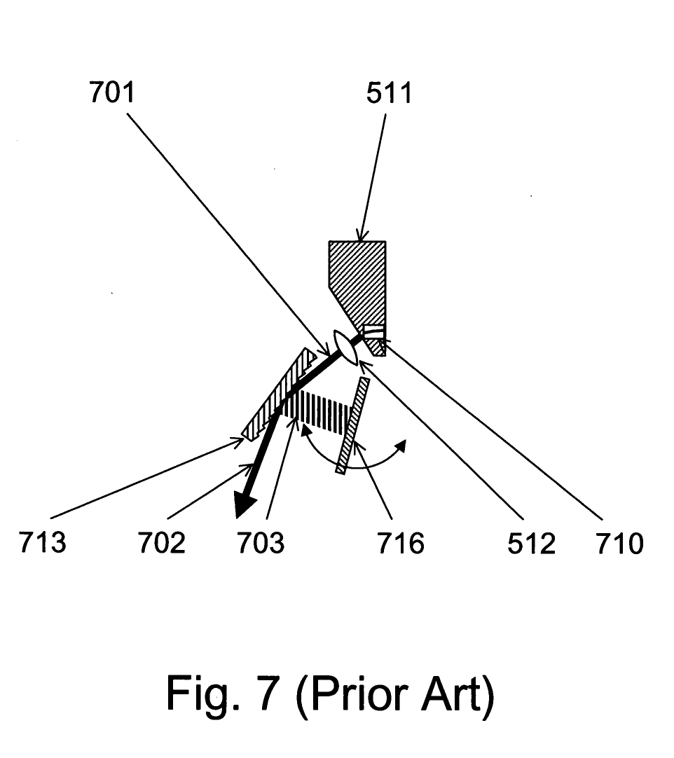

FIG. 7 describes a Littman-Metcalf configuration of the prior art where grating (713) directs first-order diffracted beam (703) onto rotatable mirror (716) and provides zeroeth-order diffracted beam (702) as usable output, such mirror being actuated by, e.g., a galvo motor (not shown) to achieve wavelength selection in the laser beam, and where gain chip (710) is designed to direct most of its output energy into cavity beam (701).

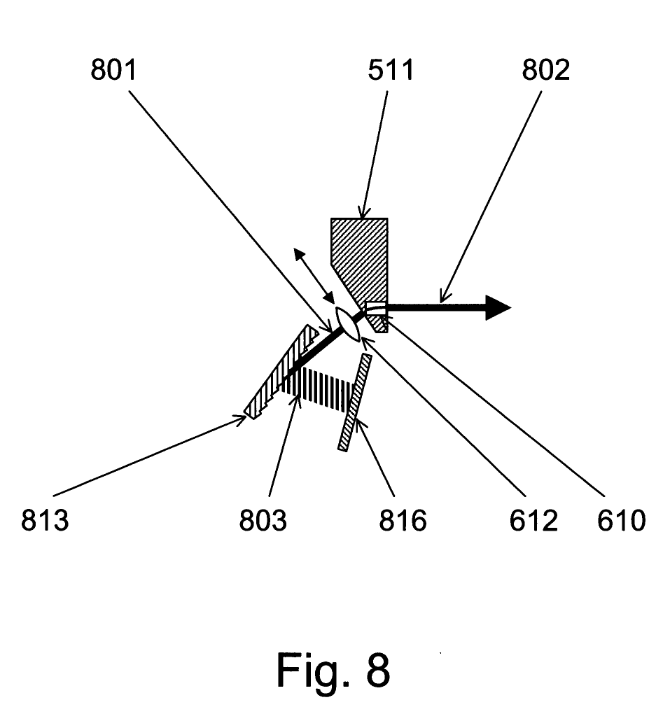

One embodiment of the present invention, as shown in FIG. 8, provides instead for a fixed mirror (816) and for a transversely (i.e., essentially perpendicular to the beam path) movable cavity lens (612), in conjunction with a grating (813) where the blaze angle is chosen to direct most of the diffracted energy into first-order beam (803) and then back into the cavity beam (801). Translation of lens (612) results in angular tuning of the cavity beam and therefore in wavelength selection through diffraction at the grating/mirror assembly. As in the embodiment exemplified by FIG. 6, the gain chip (610) is designed to provide for a substantial usable output (802) from its front facet.

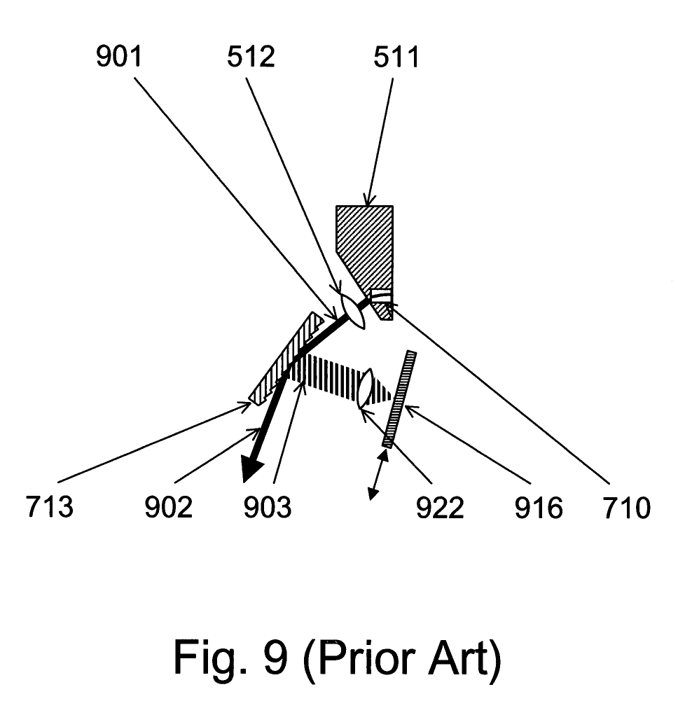

The prior art also describes a variation of the Littman-Metcalf configuration (FIG. 9) where a lens (922) is interposed in the first-order diffracted beam path (903) in order to refocus the optical radiation onto a specially designed masked mirror (916), such mirror having alternate absorbing and reflecting stripes in a predesigned pattern so as to provide relatively high reflectivity for certain wavelengths and relatively low reflectivity for certain others, or alternately having an arbitrarily designed reflectivity pattern across a certain spectral range so as to provide a corresponding spectral transfer function. The mirror is translated (by, e.g., a linear motor, not shown) to alter the spectral position of the reflectivity pattern without altering its profile, resulting in a usable output beam (902) with alterable spectral characteristics.

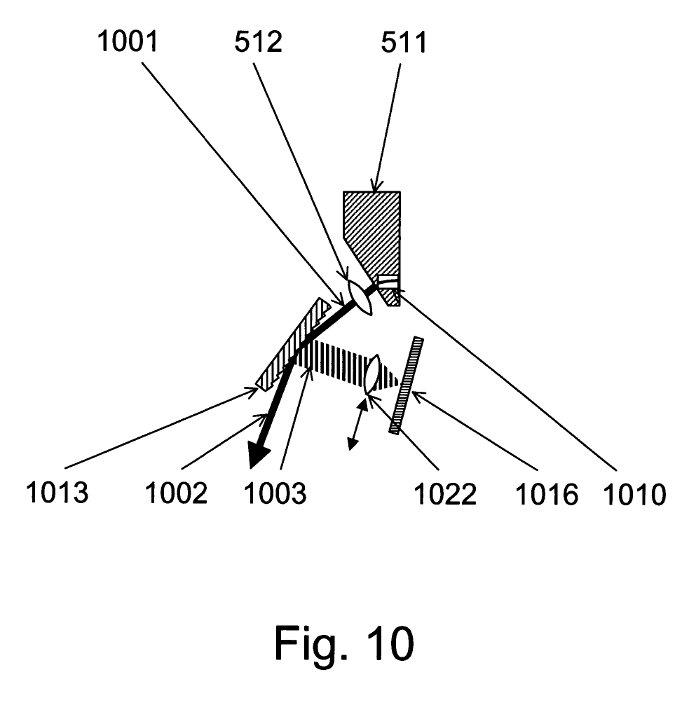

An embodiment of the present invention, shown in FIG. 10, achieves at least equivalent results by employing a stationary masked mirror (1016) and a transversely movable refocusing lens (1022), such lens being actuated by, e.g., a PZT driver (not shown) to obtain angular displacement of the diffracted beam and therefore a relative shift in the spectral transfer function defined by mirror (1022). Mirror 1016 is located one focal length from lens 1022 so that the mirror 1016 lies in the focal plane of the lens. In this way, the position of the beam at mirror 1016 is a function of its propagation angle (i.e. its diffraction angle) from the grating. Lens 1022 is preferably located close to the point of incidence of the beam on the grating. With the lens 1022 at this position, the beam will be substantially retro-reflected by the mirror 1016, and substantially retrace its path back to the chip facet. If the lens 1022 is positioned differently, then the beam reflected by mirror 1016 will be parallel to the forward propagating beam between collimating lens 512 and lens 1022, and this backward propagating beam will be incident on the chip facet at the same location as the beam emitted from the chip facet, but not at the same angle, and it will therefore not couple into the chip optimally, as it would if it were collinear with the emitted beam. In this embodiment, grating (1013) is configured to provide significant optical energy in zeroeth-order diffracted beam (1002), and gain chip (1010) is configured to direct most of its optical energy out of the facet facing the laser cavity and into cavity beam (1001).

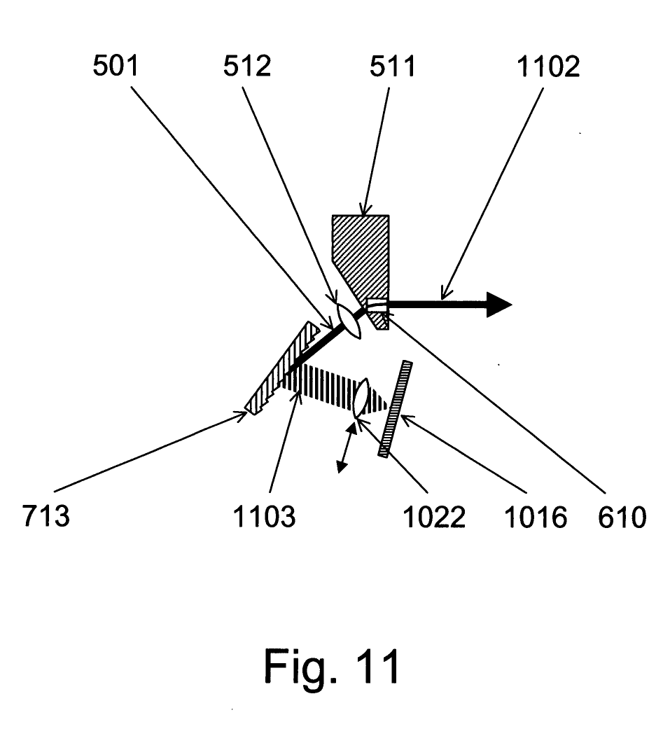

An alternative embodiment of the invention, is shown in FIG. 11 and comprises a grating (713) configured to diffract a majority of the optical energy into a first-order diffracted beam (1103) and a gain chip (610) which provides a substantial amount of optical emission shown as output beam (1102). As an alternative to lens 512, other collimating means such as a tapered waveguide can be used.

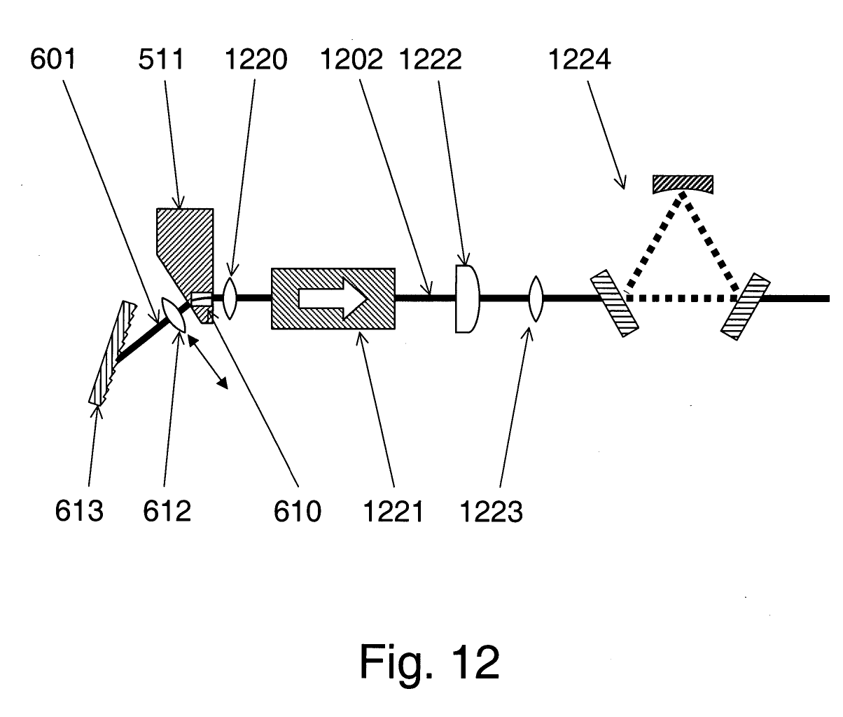

Major remaining components of a spectrometer in accordance with the present invention are shown in FIG. 12 and comprise a collimating lens (1220), an optical isolator (1221), preferably a weak lens (1222) for correcting shifts in the components when the adhesive holding them in place is cured, and a mode-matching lens or lenses (1223) for directing the light (1202) into a three-mirror ring-down cavity (1224). The use of a weak lens in this fashion is described in co-pending, commonly assigned U.S. patent application Ser. No. 10/770,141 filed Feb. 2, 2004, the teaching of which is incorporated herein by this reference.

In any of the embodiments of the invention described above, it is often advantageous either to tune the wavelength continuously and without mode hops, or to hold the wavelength fixed without mode hops. In either case, the wavelength is selected primarily by translation of the lens, and mode hops are prevented by adjusting the wavelength of the longitudinal mode of the external cavity laser, so that the diffraction efficiency function 310 remains substantially centered with respect to the incident angle 301 as shown in FIG. 3. The wavelength of the longitudinal mode may be controlled by adjusting the gain chip current and/or temperature, thus affecting the refractive index of the gain chip and hence its optical path length.

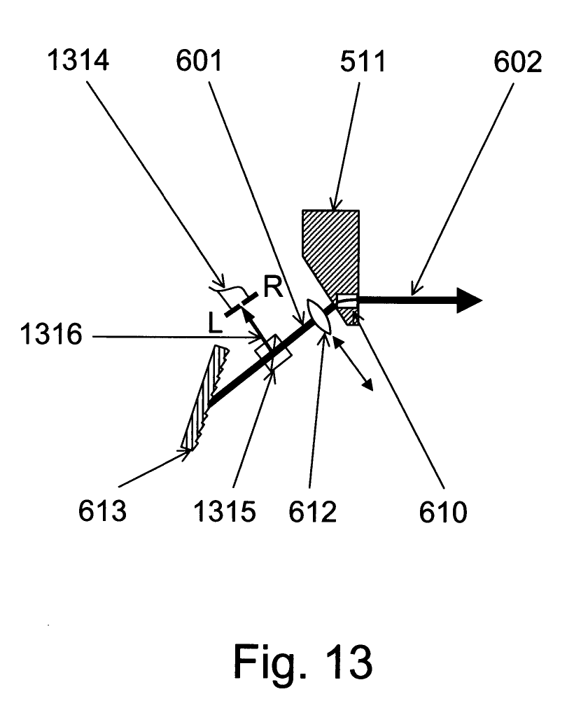

In the Littrow configuration, if and only if the function 310, as indicated in FIG. 3, is centered on the incidence angle 301, then the diffracted beam retraces its path backward through lens 612 to the gain chip facet (as, e.g., in FIG. 6). If the function 310 is not centered on the incidence angle 310, then the return path will be displaced from the forward path at the gain chip facet and at the lens 612. Monitoring the beam position at either location (or its equivalent) provides the information necessary to adjust the gain chip current or temperature to maintain centering and avoid mode hops. A dipole detector is a known device which can be used to monitor beam position. It consists of two adjacent and similar detector active areas. If a beam of light is not centered exactly between them, then one detector active area will produce a larger signal than the other. The difference in signal is a measure of the beam position perpendicular to the boundary between the active areas. In FIG. 13, a beam splitter 1315 directs a small fraction of the return beam 1316 onto such a dipole detector (shown as 1314), which measures the beam position along an axis within the plane of diffraction (the plane of the Figure). If the differential signal of the dipole detector indicates that the beam is to the left of center (“L” in the Figure), then the wavelength of the longitudinal mode should be adjusted up to recenter function 310, which usually requires decreasing the chip current or increasing the chip temperature or translation of lens 612. If the differential signal of the dipole detector indicates that the beam is to the right of center (“R” in the Figure), then the wavelength of the longitudinal mode can be adjusted down to recenter function 310, which usually requires increasing the chip current or decreasing the chip temperature. Thus, a feedback control loop may be created to prevent mode hops during either fixed or continuously tuned wavelength operation. The range of continuous, mode-hop-free tuning is primarily limited by the range of allowable gain chip current and/or temperature.

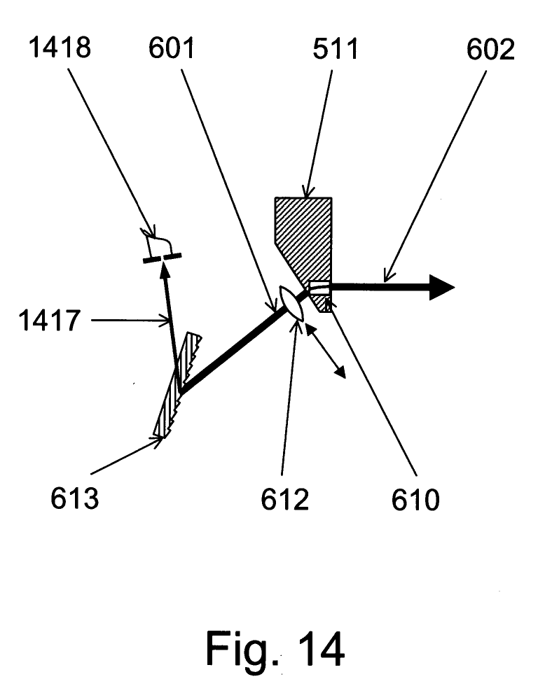

A second lens location, shown in FIG. 14, uses the 1^{st}-order diffraction of a beam transmitted through the grating. The dipole detector 1418 is placed equidistant from the grating as is the lens 612. The diffraction of the transmitted beam, shown as 1417 in FIG. 14, propagates as a mirror image (through the plane of the grating) of the backward propagating diffracted beam. This configuration is advantageous over the configuration with a beam splitter both because the beam splitter introduces optical loss of the forward beam, which is not used, and also because it has one less element, thus making it simpler and potentially cheaper. Instead, the grating is made partially transmitting (by a very small amount), and since the optimum diffraction efficiency of the grating is naturally high in a Littrow configuration, very little optical power is wasted in the undiffracted transmitted beam.

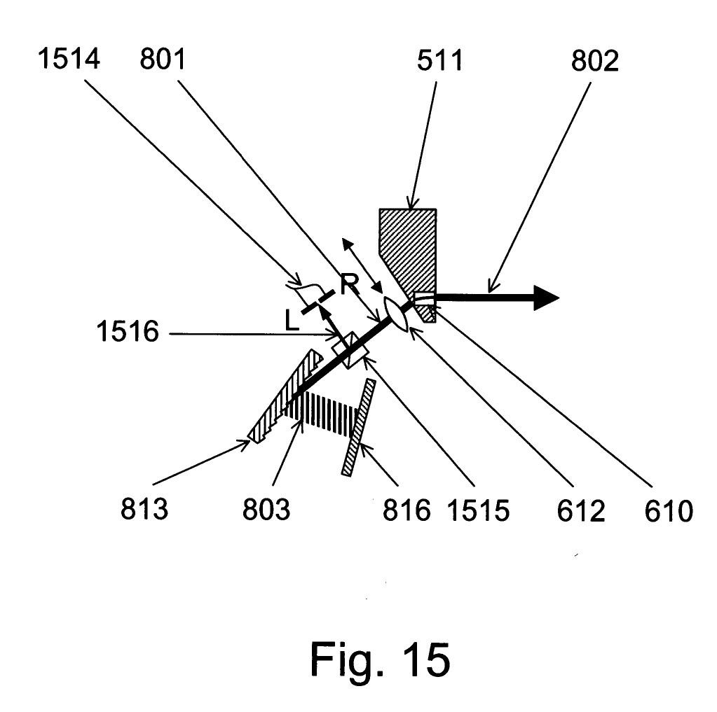

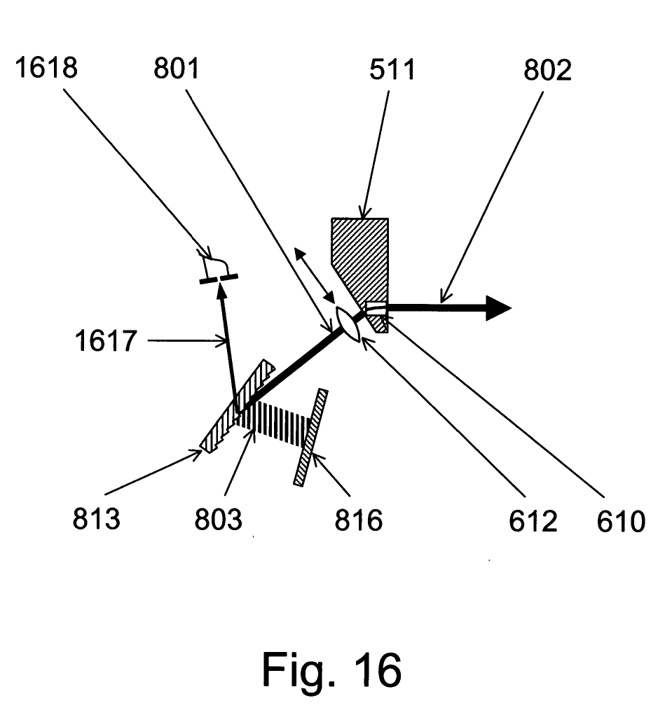

A dipole detector may be added to the Littman-Metcalf configuration shown in FIG. 8 in either of the same locations as for the Littrow configuration, as shown in FIGS. 15 and 16. Similarly to the Littrow configuration, the diffracted transmitted 2^{nd}-pass beam, shown as 1617 in FIG. 16, propagates as a mirror image of the backward propagating 2^{nd}-pass diffracted beam.

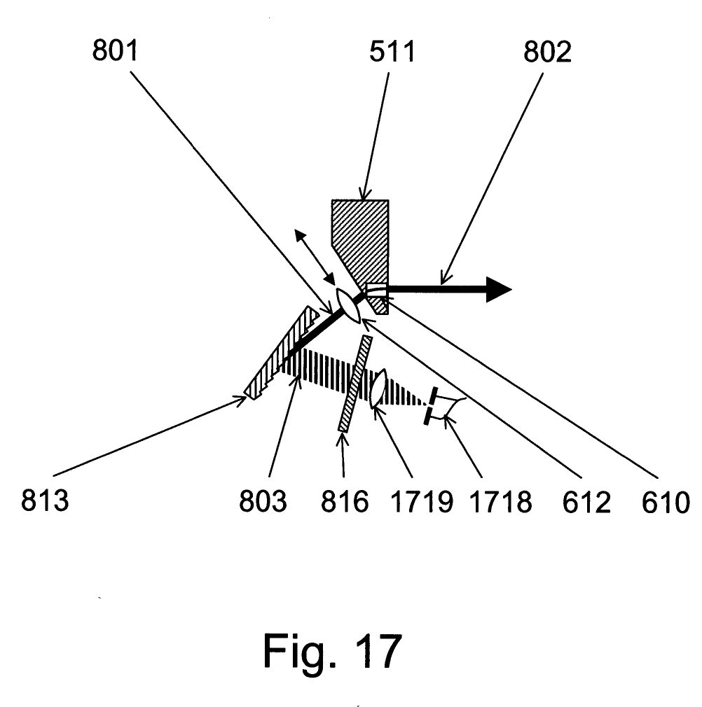

The Littman-Metcalf grating configuration shown in FIG. 8 has a third possible location for a dipole detector, shown as 1718 in FIG. 17. The optical beam is incident at 0° on mirror 816 if and only if the function 310 as indicated in FIG. 3 is centered on the grating incident angle 301. Hence, measuring the angle of incidence of the 1^{st} diffracted beam on mirror 816 provides the information necessary to adjust the gain chip current or temperature to maintain centering and avoid mode hops. This is accomplished by making mirror 816 partially transmitting, and placing a lens 1719 behind mirror 816, and the dipole detector at one focal length from the lens. Since the dipole detector is in the image plane of the lens, the beam displacement at the detector equals the angle of the beam multiplied by the lens focal length. Thus, the differential signal from this dipole detector may be used as part of a feedback control loop to prevent mode hops during either fixed or continuously tuning wavelength operation.

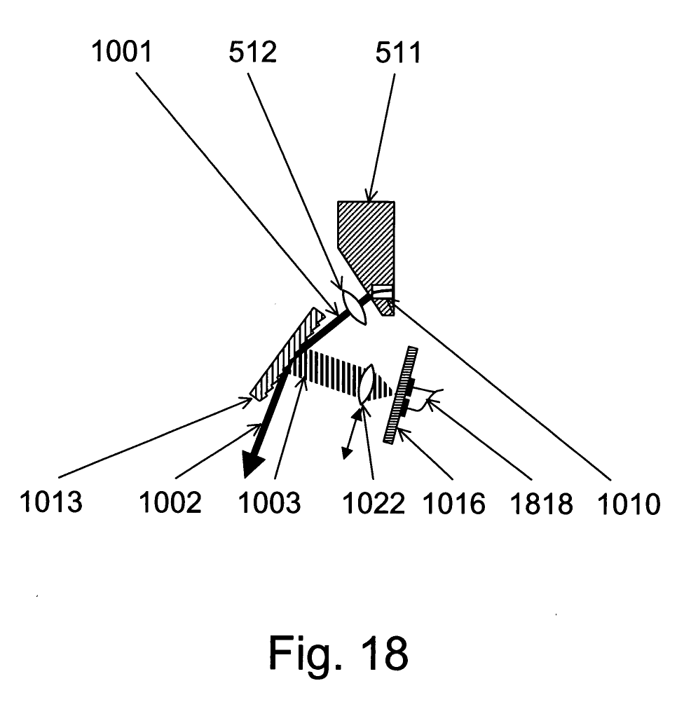

The Littman-Metcalf configuration shown in FIG. 10 suitably allocates the dipole detector 1816 as shown in FIG. 18. The configuration shown in FIG. 18 does not require that lens 1022 is positioned substantially at any particular distance from the point of incidence of the forward propagating beam 1001 on grating 1013. The 1^{st} diffracted beam is incident exactly at the reflective spot on masked mirror 1016 if and only if the function 310 as indicated in FIG. 3 is centered on the incident angle 301. Hence, measuring the position of incidence of the 1^{st} diffracted beam on mirror 1016 provides the information necessary to adjust the gain chip current or temperature to maintain centering and avoid mode hops. This is accomplished by making mirror 1016 partially transmitting, and placing the dipole detector 1818 directly behind it (ideally the dipole detector is located in the plane of mirror 1016).

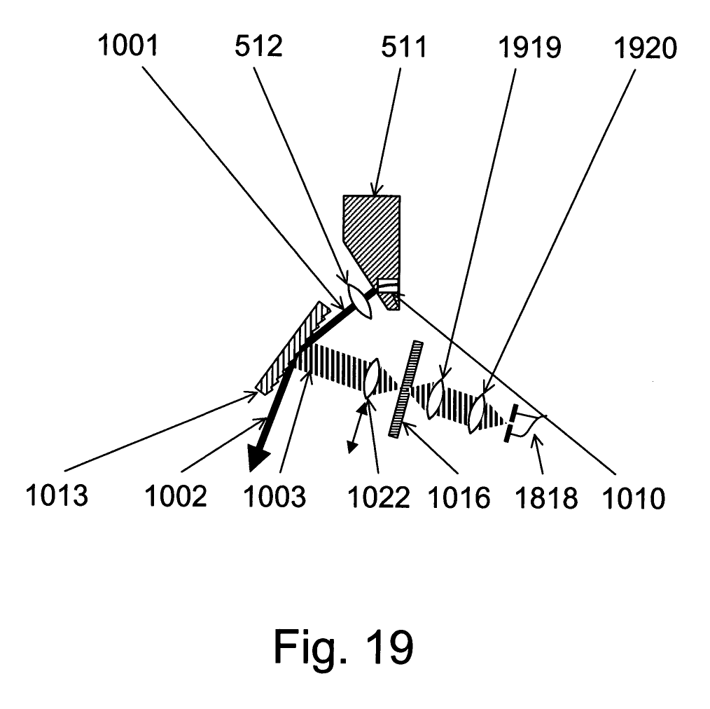

Alternatively, as shown in FIG. 19, an imaging telescope behind mirror 1016, consisting of lenses 1919 and 1920, may be used to re-image the location of incidence of the beam on mirror 1016 to an image plane behind mirror 1016 at which plane is located the dipole detector. Thus, the differential signal from this dipole detector may be used as part of a feedback control loop to prevent mode hops during either fixed or continuously tuning wavelength operation.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general. Figures are schematic only and are not intended to constitute an accurate geometric portrayal of the location of the elements shown. Further, while the present invention has been particularly described in terms of certain preferred embodiments, the invention is not limited to such preferred embodiments. Rather, the scope of the invention is defined by the appended claims.

1. A cavity-enhanced spectrometer light source comprising:
i) an electrically pumped semiconductor diode laser (SCDL) having first and second facets at least said first facet being anti-reflection coated,
ii) a diffraction grating facing said first facet,
iii) a collimating lens interposed between said facet and said diffraction grating,
iv) means for translating said lens substantially perpendicular to the path of the light beam transmitted from said SCDL to said diffraction grating to provide coarse tuning of the emission wavelength of said SCDL, and
v) means for altering at least one of the temperature of and current to said SCDL to provide fine tuning of the emission wavelength of said SCDL.

2. A spectrometer in accordance with claim 1 further comprising means for synchronizing said fine and coarse tuning.

3. A spectrometer in accordance with claim 1 wherein the blaze angle of the diffraction grating is selected to direct the majority of the energy of the beam diffracted by said grating back into the beam path from said SCDL to said diffraction grating.

4. A spectrometer in accordance with claim 3 further comprising means for synchronizing said fine and coarse tuning.

5. A spectrometer in accordance with claim 1 further comprising a stationary mirror positioned in the path of light beam diffracted by said grating.

6. A spectrometer in accordance with claim 5 wherein said mirror is partially transmitting and wherein there is a focusing lens positioned in the path of that portion of the diffracted beam which is transmitted through said mirror and wherein there is a dipole optical detector positioned in the focal plain of said lens.

7. A spectrometer in accordance with claim 1 wherein the majority of the beam diffracted by said grating is zeroeth order.

8. A spectrometer in accordance with claim 1 wherein said grating is configured to diffract a majority of the light energy transmitted from said SCDL onto said grating into a first order diffracted beam and whereby there is a substantial emission from said second facet.

9. A spectrometer in accordance with claim 1 further comprising a beam splitter positioned in said light beam path between said lens and said grating which beam splitter reflects a portion of the light diffracted by said grating back to said first facet onto a dipole optical detector.

10. A spectrometer in accordance with claim 1 wherein said diffraction grating transmits and diffracts a portion of said light beam onto a dipole optical detector.

11. A spectrometer comprising:
i) an electrically pumped SCDL having first and second facets at least said first facet being anti-reflection coated,
ii) a diffraction grating facing said first facet,
iii) collimating means interposed between said facet and said diffraction grating,
iv) a stationary mirror positioned in the path of light beam diffracted by said grating,
v) a moveable lens located between said grating and said mirror whereby transverse movement of said lens causes angular displacement of said diffracted beam
vi) means for altering at least one of the temperature of, and current to, said SCDL to provide fine tuning of the emission wavelength of said SCDL.

12. A spectrometer in accordance with claim 11 wherein said collimating means comprises a stationary collimating lens or a tapered waveguide.

13. A spectrometer in accordance with claim 11 wherein said moveable lens is positioned approximately one focal length from said mirror.

14. A spectrometer in accordance with claim 11 wherein said mirror reflects the diffracted beam back into said grating which is configured to diffract the reflected beam through said collimating means into said SCDL.

15. A spectrometer in accordance with claim 14 wherein the majority of said diffracted beam is zeroeth order.

16. A spectrometer in accordance with claim 14 further comprising means for synchronizing said fine and coarse tuning.

17. A spectrometer in accordance with claim 14 wherein said grating is configured to diffract a majority of the light energy transmitted from said SCDL onto said grating into a first order diffracted beam and whereby there is a substantial emission from said second facet.

18. A spectrometer in accordance with claim 14 wherein said mirror is partially transmitting and wherein a dipole detector is positioned immediately behind said partially transmitting mirror.

19. A spectrometer in accordance with claim 18 wherein there is a telescope situated between said mirror and said detector which telescope reimages the location of that portion of the beam transmitted by said mirror onto the front of the mirror.

20. A spectrometer comprising the light source of claim 1 and the following additional components:
vi) an optical isolator,
vii) a collimating lens positioned between said optical isolator and the output facet of said SCDL,
viii) at least one mode matching lens, and
ix) a ringdown optical cavity comprising at least three mirrors.

21. The spectrometer of claim 20 also comprising a weak lens positioned between said optical isolator and said at least one mode matching lens.

22. A spectrometer comprising the light source of claim 11 and the following additional components:
vii) an optical isolator,
viii) a collimating lens positioned between said optical isolator and the output facet of said SCDL,
ix) at least one mode-matching lens, and
x) a ringdown optical cavity comprising at least three mirrors.

23. The spectrometer of claim 22 also comprising a weak lens positioned between said optical isolator and said at least one mode matching lens.
